(19) United States
(12) Patent Application Publication
(10) Pub. No.: US 2009/0133216 A1
(43) Pub. Date: May 28, 2009

(54) HINGE APPARATUS OF MOBILE TERMINAL

(75) Inventor: Woo Chul CHO, Suwon-si (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/266,788

(22) Filed: Nov. 7, 2008

(30) Foreign Application Priority Data
Nov. 22, 2007 (KR) 10-2007-0119473

(51) Int. Cl. E05D 11/00

(52) U.S. Cl. 16/250

(57) ABSTRACT

A hinge apparatus of a mobile terminal includes a hinge housing having a circular hinge hole and at least one hooking groove disposed in an inner wall of the hinge hole, a cylindrical shaft rotatably housed in the hinge hole and having a shaft groove disposed at a position to correspond to the hooking groove, a stopper inserted in the shaft groove, wherein one end of the stopper protrudes out of the shaft groove, and a shaft spring to connect the stopper to the shaft within the shaft groove to provide an elastic force to project the stopper out of the shaft groove so as to engage the stopper with the hooking groove when the hinge housing rotates around the shaft.

### CROSS REFERENCE TO RELATED APPLICATION

This application claims priority from and the benefit of Korean Patent Application No. 10-2007-0119473, filed on Nov. 22, 2007, which is hereby incorporated by reference for all purposes as if fully set forth herein.

### BACKGROUND OF THE INVENTION

1. Field of the Invention

The present invention relates to a hinge apparatus of a mobile terminal, and more particularly, to a hinge apparatus of a mobile terminal having a shaft and a hinge housing rotatably fastened along one axis.

2. Discussion of the Background

In general, a mobile terminal may be classified as a bar type, a flip type, a folder type, or a slide type according to an external shape thereof The flip type mobile terminal includes a main body, a flip body, and a hinge apparatus to connect the main body to the flip body. The folder type mobile terminal includes a main body, a folder body, and a hinge apparatus to connect the main body to the folder body. The hinge apparatus is rotatably connected to the main body and the flip body and is used to open or close the flip body or the folder body with respect to the main body.

However, the hinge apparatus of the mobile terminal is used only to open and close the flip body or the folder body with respect to the main body and does not provide for the adjustment of the opening angle of the flip body or the folder body with respect to the main body. Therefore, there may be many restrictions when changing a specification of the mobile terminal. Accordingly, it may be difficult for the mobile terminal to provide various services.

### SUMMARY OF THE INVENTION

The present invention provides a hinge apparatus of a mobile terminal that may easily adjust the opening angle of the flip body or the folder body with respect to the main body of the mobile terminal.

Additional features of the invention will be set forth in the description which follows, and in part will be apparent from the description, or may be learned by practice of the invention.

The present invention discloses a hinge apparatus of a mobile terminal including a hinge housing having a circular hinge hole and at least one hooking groove disposed in an inner wall of the hinge hole, a cylindrical shaft rotatably housed in the hinge hole and having a shaft groove disposed at a position corresponding to the hooking groove, a stopper inserted in the shaft groove, wherein one end of the stopper protrudes out of the shaft groove, and a shaft spring to connect the stopper to the shaft within the shaft groove to provide an elastic force to project the stopper out of the shaft groove so as to engage the stopper with the hooking groove when the hinge housing rotates around the shaft.

The present invention also discloses a hinge apparatus of a mobile terminal including a hinge housing having a hinge hole and a plurality of hooking grooves disposed in an inner wall of the hinge hole, a first shaft rotatably housed in the hinge hole and having at least one shaft groove, a shaft spring disposed in the shaft groove, and a stopper including a head and a stem. The stem of the stopper is disposed within the shaft spring and the head of the stopper is disposed on top of the shaft spring. The shaft spring forces the head of the stopper to engage with one of the hooking grooves when the hinge housing rotates around the shaft to a position at which the shaft groove faces the hooking groove.

The present invention also discloses a mobile terminal including a main body, a second body and a hinge apparatus to couple the main body with the second body. The hinge apparatus includes a hinge housing having a hinge hole and a plurality of hooking grooves disposed in an inner wall of the hinge hole, a first shaft rotatably housed in the hinge hole and having at least one shaft groove, a shaft spring disposed in the shaft groove, and a stopper including a head and a stem. The stem of the stopper is disposed within the shaft spring and the head of the stopper is disposed on top of the shaft spring. The shaft spring forces the head of the stopper to engage with one of the hooking grooves when the hinge housing rotates around the shaft to a position at which the shaft groove faces the hooking groove.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an exploded perspective view showing a configuration of a hinge apparatus of a mobile terminal according to an exemplary embodiment of the present invention.

FIG. 2A, FIG. 2B, FIG. 3A, and FIG. 3B are views showing hinge operations of the hinge apparatus of the mobile terminal of FIG. 1.

FIG. 4 is an exploded perspective view showing a configuration of a hinge apparatus of a mobile terminal according to another exemplary embodiment of the present invention.

FIG. 5A and FIG. 5B are views showing hinge operations of the hinge apparatus of the mobile terminal of FIG. 4.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

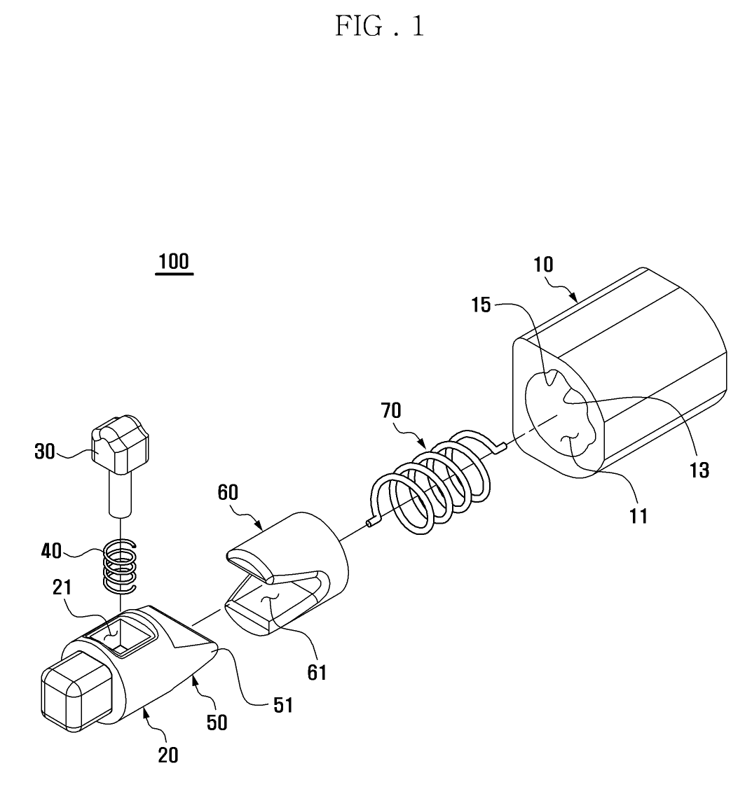

FIG. 1 is an exploded perspective view showing a configuration of a hinge apparatus 100 of a mobile terminal according to an exemplary embodiment of the present invention.

Referring to FIG. 1, the hinge apparatus 100 includes a hinge housing 10, shaft 20, stopper 30, shaft spring 40, hinge cam 50, hinge shaft 60, and housing spring 70.

The hinge housing 10 is connected to a flip body (not shown) or a folder body (not shown) of the mobile terminal. The hinge housing 10 has a circular hinge hole 11 to house the shaft 20, stopper 30, shaft spring 40, and hinge cam 50. The shaft 20 may be cylindrical. The hinge housing 10 has at least one hooking groove 15 disposed in an inner wall 13 of the hinge hole 11.

The at least one hooking groove 15 is parallel to the central axis of the hinge hole 11. When there is more than one hooking groove 15, the hooking grooves 15 may be arranged at intervals around the circumference of the hinge hole 11.

The shaft 20 connects the hinge housing 10 to a main body (not shown) of the mobile terminal. Part of the shaft 20 is inserted into the main body of the mobile terminal and fixed thereto, and the remaining part of the shaft 20 is housed in the hinge hole 11 of the hinge housing 10 such that the hinge housing 10 can rotate around the shaft 20. A shaft groove 21 is formed in the shaft 20 at a position that corresponds to the hooking groove 15 when the shaft 20 is housed in the hinge housing 10. When the hinge housing 10 rotates around the shaft 20, the hooking groove 15 rotates to a position beyond that of the shaft groove 21.

The stopper 30 is inserted into the shaft groove 21 of the shaft 20 through one end of the shaft groove 21. The outer end of the stopper 30 is exposed from the shaft 20. The projecting exposed end of the stopper 30 may have a form corresponding to that of the hooking groove 15.

Further, the shaft spring 40 connects the shaft 20 and the stopper 30 within the shaft groove 21. When the hinge housing 10 rotates around the shaft 20, the shaft spring 40 provides an elastic force so that the stopper 30 extends outward from the shaft groove 21 to engage with the hooking groove 15. When the stopper 30 is disengaged from the hooking groove 15, the shaft spring 40 is compressed by the stopper 30.

The hinge cam 50 is formed at the end of the shaft 20 that is inserted into the hinge housing 10. The hinge cam 50 has a protruding portion 51 having an inclined surface inclined at an angle with respect to the rotational axis of the shaft 20.

The hinge shaft 60 is housed in the hinge hole 11 of the hinge housing 10 and has a recessed portion 61 to engage with the protruding portion 51 of the hinge cam 50.

The housing spring 70 connects the hinge shaft 60 and the hinge housing 10 within the hinge hole 11 such that the housing spring 70 exerts a torsional force opposing rotation of the hinge shaft 60. When the hinge housing 10 rotates around the shaft 20, the housing spring 70 provides an elastic force to the hinge shaft 60 so that the recessed portion 61 disengages from the protruding portion 51 of the hinge cam 50. When the recessed portion 61 is disengaged from the protruded portion 51, the housing spring 70 is contracted by the hinge shaft 60.

That is, the hinge shaft 60 can reciprocate along the rotational axis in which the shaft 20 and the hinge housing 10 are rotationally connected by extension and contraction of the housing spring 70. The hinge shaft 60 contacts the hinge cam 50 while performing a reciprocating motion.

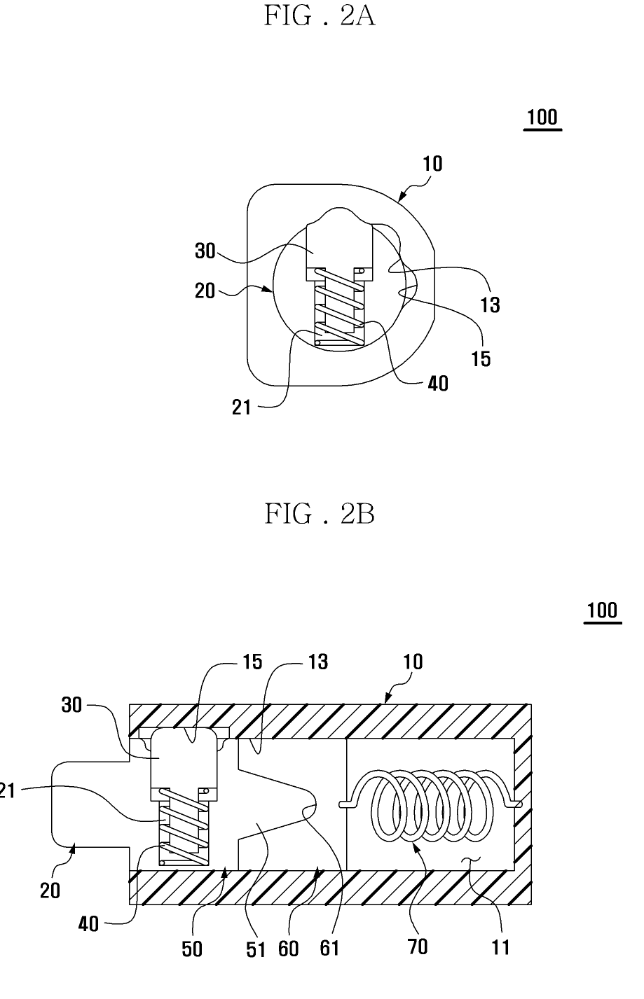

FIG. 2A, FIG. 2B, FIG. 3A, and FIG.3B are views showing hinge operations of the hinge apparatus 100 of the mobile terminal of FIG. 1.

Referring to FIG. 2A, FIG. 2B, FIG. 3A, and FIG. 3B, in the present exemplary embodiment, it is assumed that from an initial state in which a flip body or a folder body is closed on a main body of the mobile terminal, the flip body or the folder body is opened from the main body by a user of the mobile terminal.

When the flip body or the folder body of the mobile terminal is closed on the main body, the outer projecting end of the stopper 30 is engaged with one of the at least one hooking grooves 15 of the hinge housing 10 by the shaft spring 40, as shown in FIG. 2A. As shown in FIG. 2B, the hinge cam 50 is engaged with the hinge shaft 60. Accordingly, unintentional rotation of the hinge housing 10 around the shaft 20 may be prevented.

Next, if a force to open the flip body or the folder body of the mobile terminal is applied, the hinge housing 10 rotates around the shaft 20 in a direction corresponding to the force. The outer end of the stopper 30 is disengaged from the hooking groove 15 to contact with the inner wall 13 of the hinge housing 10 while applying a compressive force to the shaft spring 40, as shown in FIG. 3A. The shaft spring 40 is compressed to provide an elastic force to cause the stopper 30 to protrude. The protruding portion 51 of the hinge cam 50 disengages from the recessed portion 61 of the hinge shaft 60, as shown in FIG. 3B. That is, an inclined surface of the protruding portion 51 of the hinge cam 50 disengages from a corresponding inclined surface of the housing shaft 60. The housing spring 70 is compressed to provide an elastic force to the hinge shaft 60 so as to retain contact between the hinge shaft 60 and the hinge cam 50.

Finally, when the hinge housing 10 rotates around the shaft 20 such that the outer end of the stopper 30 is positioned to correspond to another hooking groove 15, the shaft spring 40 causes the outer end of the stopper 30 to extend out of the shaft 20 to engage with the hooking groove 15. Accordingly, unintentional rotation of the hinge housing 10 around the shaft 20 may be prevented. In this case, if a force to open the flip body or the folder body relative to the main body of the mobile terminal ceases because the stopper 30 is engaged with the hooking groove 15 and the hinge cam 50 is in contact with the hinge shaft 60, the hinge apparatus 100 is in a stable state. That is, the flip body or the folder body of the mobile terminal remains in the stable state at an angle with respect to the main body.

If a force to open or close the flip body or the folder body relative to the main body of the mobile terminal is applied, the hinge apparatus 100 may repeatedly perform a process similar to that shown in FIG. 2A, FIG. 2B, FIG. 3A, and FIG. 3B. Accordingly, the hinge apparatus 100 enables a user of the mobile terminal to easily adjust a position of the flip body or the folder body of the mobile terminal to an angle relative to the main body.

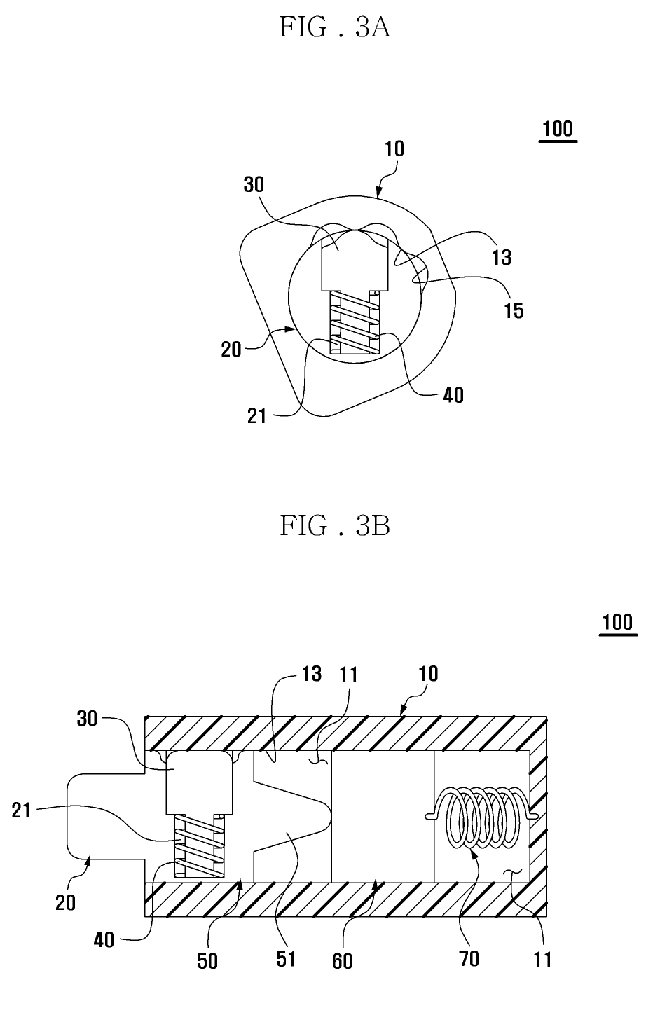

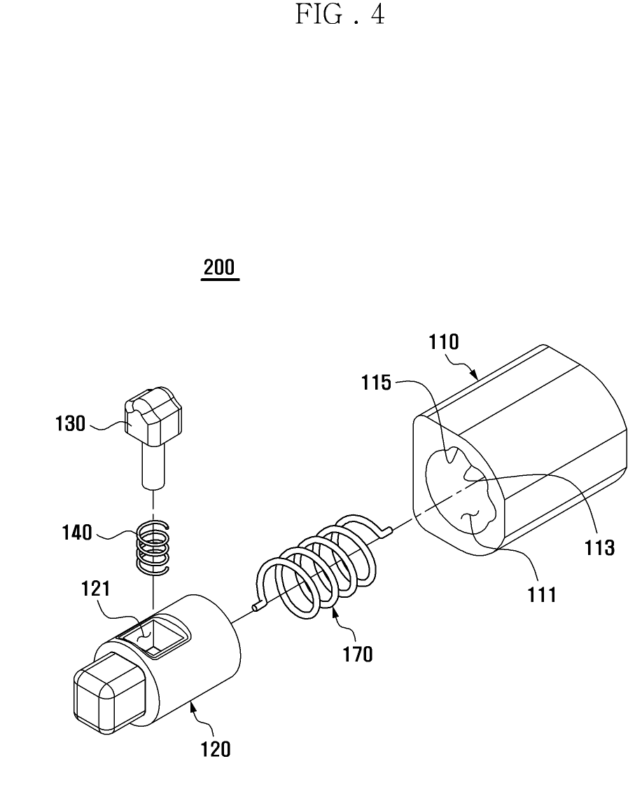

FIG. 4 is an exploded perspective view showing a configuration of a hinge apparatus 200 of a mobile terminal according to another exemplary embodiment of the present invention.

Referring to FIG. 4, the hinge apparatus 200 includes a hinge housing 110, shaft 120, stopper 130, shaft spring 140, and housing spring 170. The hinge housing 110, the shaft 120, the stopper 130, and the shaft spring 140 of the present exemplary embodiment are similar to those of the above-described exemplary embodiment and therefore a detailed description thereof is omitted. However, in the present exemplary embodiment, the housing spring 170 is fixed to an end of the shaft 120 and to the hinge housing 110 within the hinge hole 111. When the hinge housing 110 rotates around the shaft 120, the housing spring 170 exerts a rotational elastic force on the hinge housing 110 that opposes the rotation of the hinge housing 110 by twisting the housing spring 170.

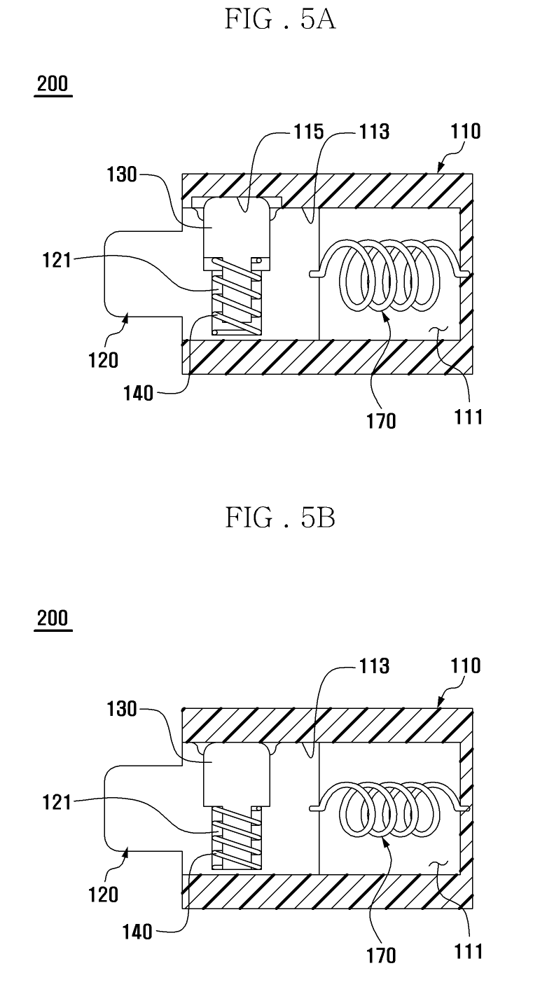

FIG. 5A and FIG. 5B are views showing hinge operations of the hinge apparatus 200 of the mobile terminal of FIG. 4.

Referring to FIG. 5A and FIG. 5B, in the present exemplary embodiment, it is assumed that from an initial state in which a flip body or a folder body of the mobile terminal is closed on a main body, the flip body or the folder body is opened from the main body of the mobile terminal by the user of the mobile terminal. In this case, the stopper 130 operates as in the above-described exemplary embodiment and therefore a detailed description thereof is omitted.

First, when the main body and the flip body or the folder body of mobile terminal are closed, the housing spring 170 sustains a stable state, as shown in FIG. 5A.

Next, if a force to open the flip body or the folder body is applied, the hinge housing 110 rotates around the shaft 120 in a direction corresponding to the force. The housing spring 170 is twisted while rotating together with the hinge housing 110, as shown in FIG. 5B. The housing spring 170 provides an elastic force to return the hinge housing 110 to the stable state from the twisted state. That is, an elastic force provided by the housing spring 170 opposes rotation of the hinge housing 110 around the shaft 120.

Finally, as the hinge housing 110 rotates around the shaft 120, when the outer end of the stopper 130 is positioned to correspond to another hooking groove 115, the shaft spring 140 causes the outer end of the stopper 130 to extend out of the shaft 120 to engage with the hooking groove 115. Accordingly, unintentional rotation of the hinge housing 110 around the shaft 120 may be prevented. In this case, if a force to open the flip body or the folder body relative to the main body of the mobile terminal ceases because the stopper 30 is engaged with the hooking groove 15, the hinge apparatus 110 sustains a stable state. That is, the flip body or the folder body of the mobile terminal remains in the stable state at an angle with respect to the main body.

If a force to further open the flip body or the folder body relative to the main body of the mobile terminal is applied, the hinge apparatus 200 repeatedly performs a process similar to that of FIG. 5A and FIG. 5B. If a force to close the flip body or the folder body relative to the main body of the mobile terminal is applied, the hinge apparatus 200 returns to the state shown in FIG. 5A from the state shown in FIG. 5B. Accordingly, the hinge apparatus 200 may enable a user of the mobile terminal to easily adjust a position of the flip body or the folder body from the main body of the mobile terminal. That is, the flip body or the folder body of the mobile terminal is fixed in an opened state at an angle to the main body thereof. In addition, due to an elastic torsional force of the housing spring 170, the hinge apparatus 200 may more easily close the flip body or the folder body on the main body of the mobile terminal.

In the above-described exemplary embodiments, in the hinge apparatus, the shaft is connected to the main body of the mobile terminal and the hinge housing is connected to the flip body or the folder body of the mobile terminal, however, the connection of the shaft and the hinge housing to the mobile terminal is not limited thereto. That is, the shaft may be connected to the flip body or the folder body of the mobile terminal and the hinge housing may be connected to the main body of the mobile terminal. In this case, if a force to open the flip body or the folder body is applied, the shaft rotates in a direction around the hinge housing corresponding to the force.

As described above, according to exemplary embodiments of the present invention, due to a structure in which the stopper and the hooking groove of the hinge housing are engaged by the elastic force of the shaft spring, an opening angle of the flip body or the folder body relative to the main body of the mobile terminal may be easily adjusted. According to a structure of the hinge apparatus in which a hinge cam and a hinge shaft are engaged by the elastic force of the housing spring, an opening angle of the flip body or the folder body relative to the main body of the mobile terminal may be adjusted more easily. Further, according to a structure of the hinge apparatus in which a twisting force is exerted by the housing spring, the flip body or the folder body of the mobile terminal may be closed more easily. Therefore, because the structure of the hinge apparatus provides for the angle of opening of the flip body or the main body to be adjusted, a specification of the mobile terminal may be easily changed, thus enabling the mobile terminal to provide various services.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A hinge apparatus of a mobile terminal, comprising:
a hinge housing having a circular hinge hole and a hooking groove disposed in an inner wall of the hinge hole;
a cylindrical shaft rotatably housed in the hinge hole, the shaft having a shaft groove disposed at a position corresponding to the hooking groove;
a stopper inserted in the shaft groove, wherein one end of the stopper protrudes out of the shaft groove; and
a shaft spring to connect the stopper to the shaft within the shaft groove to provide an elastic force to project the stopper out of the shaft groove so as to engage the stopper with the hooking groove when the hinge housing rotates around the shaft.

2. The hinge apparatus of claim 1, wherein the hinge housing comprises a plurality of hooking grooves disposed parallel to an axis of rotation of the hinge housing, the hooking grooves being disposed at intervals around the circumference of the hinge hole.

3. The hinge apparatus of claim 2, further comprising:
a hinge cam fixedly attached to an inner end of the shaft housed in the hinge hole of the hinge housing, the hinge cam comprising a protruding portion having an inclined surface;
a hinge shaft comprising a recessed portion to engage with the protruding portion of the hinge cam, the recessed portion being housed in the hinge hole of the hinge housing; and
a housing spring installed in the hinge hole, the housing spring having a first end connected to the hinge shaft and a second end connected to the hinge housing, the housing spring to provide an elastic force to the hinge shaft so that the recessed portion of the hinge shaft engage with the protruding portion of the hinge cam when the hinge housing rotates around the shaft.

4. The hinge apparatus of claim 2, further comprising:
a housing spring installed in the hinge hole, the housing spring having a first end fixed to the shaft and a second end fixed to the hinge housing,
wherein the housing spring exerts a rotational elastic force on the hinge housing by twisting when the hinge housing rotates around the shaft.

5. A hinge apparatus of a mobile terminal, comprising:
a hinge housing having a hinge hole and a plurality of hooking grooves disposed in an inner wall of the hinge hole;
a first shaft rotatably housed in the hinge hole and having at least one shaft groove;
a shaft spring disposed in the shaft groove; and
a stopper comprising a head and a stem, the stem being disposed within the shaft spring and the head being disposed on top of the shaft spring,
wherein the shaft spring forces the head of the stopper to engage with one of the hooking grooves when the hinge housing rotates around the first shaft to a position at which the shaft groove faces the hooking groove.

6. The hinge apparatus of claim 5, further comprising:
a second shaft housed in the hinge hole of the hinge housing, the second shaft comprising a recessed portion;
a hinge cam disposed at an end of the first shaft, the hinge cam comprising a protruding portion to engage with the recessed portion of the second shaft; and
a housing spring to connect the second shaft and the hinge housing within the hinge hole,
wherein the housing spring provides an elastic force to disengage the protruding portion and the recess portion when the hinge housing rotates around the first shaft.

7. The hinge apparatus of claim 5, further comprising:
a housing spring fixed to an end of the first shaft and to the hinge housing within the hinge hole,
wherein the housing spring twists to exert a rotational elastic force on the hinge housing that opposes the rotation of the hinge housing when the hinge housing rotates around the first shaft.

8. The hinge apparatus of claim 5, wherein the first shaft is cylindrical and the hinge hole is circular.
